(19) United States
(12) Patent Application Publication
(10) Pub. No.: US 2009/0166523 A1
(43) Pub. Date: Jul. 2, 2009

(54) USE OF CARBON NANOTUBES (CNTS) FOR ANALYSIS OF SAMPLES

(75) Inventors: Peter Klaus Bachmann, Wuerselen (DE); Helga Hummel, Aachen (DE); Detlef Uwe Wiechert, Alsdorf (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., Eindhoven (NL)

(21) Appl. No.: 11/568,194

(22) PCT Filed: Apr. 12, 2005
(86) PCT No.: PCT/IB05/51193

§ 371 Date: Oct. 23, 2006

(30) Foreign Application Priority Data
Apr. 27, 2004 (EP) 04101762.5

(51) Int. Cl. B01D 59/44; H01J 49/00

(52) U.S. Cl. 250/282; 250/281

(57) ABSTRACT

The present invention relates to the use of carbon nanotubes as a substrate for chemical or biological analysis. The invention further relates to the use of this material in separation adherence and detection of chemical of biological samples. Carbon nanotubes are envisaged as surface material of a fixed substrate or in suspension and applications include but are not limited to processes which involve desorption-ionization of a sample, more specifically mass spectroscopy.

The present invention is directed to compositions for use as substrate and/or matrix material in desorption-ionization analytics as well as apparatus using the compositions for analysis.

Mass spectrometry (MS) is used to measure the mass of a sample molecule, as well as the mass of the fragments of a sample to identify that sample. It has become an indispensable tool for the analysis of biological molecules such as proteins and peptides, and the widespread use of MS is a reflection of its ability to solve structural problems not readily or conclusively determined by conventional techniques. Besides its established value for the analysis of unknown sample, MS is finding additional applications in high-throughput analytics and diagnostics, e.g. to generate diagnostically relevant peptide patterns from serum and tissue (Petricoin III E F et al, 2002, Lancet 359: 572-77).

Basically, MS analysis comprises the degradation of a sample into molecules which are converted to gas-phase ions by an ionizer, separation of these ions in a mass analyzer and detection by an electron multiplier. The result is a spectrum, which represents the ratio of the mass of the molecules to the corresponding ion's electric charge.

The most commonly used analyzers are either based on acceleration of the ions into a magnetic field or time-of-flight (TOF). TOF accelerates the sample ion with a known voltage, and measures how long it takes an ion to travel a known distance. Alternatively, a selection of molecules within a specific range mass can be obtained by passing the ions through magnetic poles of which the polarities are rapidly alternated.

Time-of-flight analysis can further be improved by the provision of a reflectron or ion mirror, which has an applied voltage, which is slightly higher than the accelerating voltage at the source, so that the ions are subjected to a repelling electrical field. This improves the resolution of the detection.

Ionization of the samples can either be performed by electrospray ionization (ESI) or by desorption ionization, the latter allowing analysis of molecules that are not easily rendered gaseous by starting from a sample adsorbed on a substrate. The technique of direct desorption ionization has not been extensively used, because rapid molecular degradation and fragmentation are usually observed upon direct exposure of the molecules to laser radiation. An important improvement in desorption mass spectrometry was the introduction of an organic matter as a vehicle for desorbing and ionizing the sample, a technique now also referred to as matrix-assisted laser desorption/ionization (MALDI). The matrix is added in large excess to the sample material and is believed to act as both an efficient proton absorber and energy transmitter to the molecules. As UV lasers are common in MALDI-MS, matrix molecules that absorb UV light are required (dihydrobenzoic acid or trans-cinnamic acid are very common).

MALDI, though very widely used is limited by the signal noise introduced by the matrix itself. In the MALDI approach, the molecular solution to be analyzed is mixed into an organic resin, which is placed on a sample plate and allowed to solidify. The sample plate, which can hold a number of samples, is loaded into a vacuum chamber where the “time of flight” analysis is performed. An organic matrix on a substrate holds the molecular species to be detected while acting as an energy absorber. A laser then impinges on the matrix-analyte mixture, and, when the matrix absorbs the laser energy, it vaporizes. The resulting desorbed molecules, which include the analyte and matrix components, are then mass analyzed. Matrix material molecules add to the collected signal, however, preventing the detection of smaller molecules. The inclusion of the matrix molecules into the collected signal limits the low mass detection of this method to above 500 amu, but it has proven to be effective for analyzing a large range of molecules up to approximately 100,000 amu. Thus, for analysis of low mass analytes (<m/z 500), irreproducible and heterogeneous co-crystallization, suppression of ionization by electrolytes and other additives, and interference from matrix ions have limited the utility of MALDI in automated high-throughput combinatorial and chip-array analyses. Besides low mass and noise limitations, further downfalls of this system lie in the sample preparation itself, because the matrix/sample mixture requires experienced chemical handling, usually requires time-consuming drying, and has throughput limitations for large scale clinical applications. The use of matrix material often requires additional washing steps and chemical compatibility of the matrix, solvent and sample. Finally, for each laser wavelength (e.g. visible or IR), an adapted matrix has to be used.

A variation of this technology, referred to as SELDI (surface enhanced laser desorption/ionization) or SALDI (surface assisted laser desorption/ionization) MS, involves the interaction of samples with surfaces prior to and during vaporization for MS. The surfaces are modified in such a way that interaction with the (bio) analyte results in a selective retention (or release) of material, similar to a cleaning process. This ultimately leads to improved MS spectra, i.e. better S/N ratios, lower background and/or allowing a more conclusive identification of the MS-peaks or peak patterns. Desorption ionization has been achieved from electrochemically etched conventional porous silicon. (Thomas J. et al. 2001, Proc. Natl. Acad. Sci. 98(9):4932-4937). US2002/0048531 describes the use of a porous light-absorbing semiconductor substrate such as silicon, more particularly vapor-deposited films for desorption ionization in visible DIOS-MS. However, surface chemistries of porous silicon surfaces are not favorable for specific functionalization (no carbon chemistry) and silicon surfaces are regularly oxidized resulting in contact resistance. Junghwan et al (2002) describe the potential advantage of using of a graphite plate as a photon-absorbing material in combination with glycerol as a proton source in SALDI-MS.

Carbon nanotubes were discovered by a Japanese electron microscopist in 1991 while studying the material deposited on a cathode during the arc-evaporation synthesis of fullerenes. This was soon followed by a laser ablation technique developed at Rice University. In the last few years, chemical vapor deposition (CVD) has become a common technique to grow nanotubes. Carbon nanotubes consist of graphitic layers seamlessly wrapped to cylinders, with only a few nanometers in diameter but up to a millimeter in length. As this truly molecular nature was unprecedented for macroscopic devices of this size, the number of both specialized and large-scale applications has grown constantly.

Nanotubes and other nanomaterials efficiently carry charge and excitons. Therefore, over the past decade, the synthesis of various nanomaterials has attracted attention due to their potential to serve as building blocks for emerging nanoscale devices. Among them, the electronic and sensing properties of nanowires and nanotubes have been widely studied because of their nanoscale dimensions and high surface-to-volume ratios.

Growth of carbon nanotubes and other nanomaterials by catalyst-supported chemical vapor deposition processes, e.g. thermal CVD or plasma CVD processes is in general known. Plasma-grown CNTs can be grown vertically aligned from gas mixtures that contain a carbon carrier (methane, acetylene or other), hydrogen, and other gases (ammonia, nitrogen). Properties and structure of CNTs may be found in the ‘Handbook of Nanoscience, Engineering and Technology’, Edited by W. A. Goddard, III; D. W. Brenner, S. E. Lyshevski and G. J. Lafrate, CRC Press, 2003.

Moreover, it is known, that carbon nanotubes may be used as relevant components in sensors. Sensor elements that use e.g. changes of the carbon nanotube properties upon gas adsorption or other surface modifications are known. In such devices and sensors, the carbon nanotubes are contacted by positioning them horizontally across electrode stripes. Electron transport phenomena or conductivity changes upon surface modifications are measured this way. Indirect measurements by capacitance changes are used as a possible, rather difficult to measure alternative, with limited practical relevance.

The present invention relates to the use of carbon nanotubes (CNTs) as substrate or matrix material in methods for detection of analytes in a sample. The present invention also relates to the use of carbon nanotubes (CNTs) as a substrate and/or matrix material in desorption-ionization analytics. More particularly the CNTs of the present invention are advantageous for use in detection methods of analytes which involve the discharging of energy on the sample, thereby transforming the analytes in the sample into charged particles, which are subsequently detected by a detector. More particularly, CNTs, according to the present invention, provide specific advantages for use in Mass spectrometry (MS) analysis. More specifically the material of the present invention can be used as a substrate, substrate surface or as a suspension in SELDI or MALDI-like analysis.

Thus, according to a first aspect of the invention carbon nanotubes (CNTs) are used in a method for detection of analytes in a sample.

A particular embodiment of the present invention relates to the use of the carbon nanotubes as a substrate or substrate surface coating in desorption/ionization analytics. More particularly, the material of the invention is suitable as a substrate surface in mass spectrometry analysis.

An important advantage of the application of CNTs according to this aspect of the invention is that, due to the characteristics of said CNTs, addition of (other) matrix material and its inherent disadvantages can be avoided or minimized.

Another important advantage of the application of CNTs in the present invention is that it can be modified by a wide variety of organo-chemical reactions in order to improve substrate characteristics and/or to allow selective adherence and/or release of analytes in a sample or to introduce polarities. Thus according to a particular embodiment of the invention the surface comprising the CNTs is modified or functionalized by chemical modifications. Chemical functionalization can be achieved by molecules including reactive, non-reactive, organic, organo-metallic and non-organic species. More particularly, chemical modification can comprise steps such as oxidation, reduction, addition of chemical groups.

Another important advantage of the application of CNTs in the present invention is that they are electrically conductive. When CNTs are used as a surface material on a supported structure, this surface can, if desired, be contacted via the supporting structure. Thus it is possible to apply constant, alternating or pulsed electrical potentials to the sample or analytes thereof immobilized or absorbed on the CNT surface.

A further advantage of the use of CNTs in the present invention is that, contrary to conventional matrices, they provide highly oriented surfaces with a well-defined, predetermined structure that can act as matrix and scaffold for bio-polymers. This helps to enhance capture probe reactivity and efficiency at the surfaces and allows the orientation of the biopolymer along the surface topology to create improved S/N ratios.

A further advantage of the application of CNTs in the present invention is that they quickly absorb laser energy over an extended wavelength region and that they heat up rapidly in vacuum and thus transfer energy efficiently and effectively to the sample under investigation.

According to a particular embodiment of the invention, the CNTs are loaded with hydrogen or hydrogen is induced as structural defects during growth, in order to allow excited proton transfer.

Thus, one aspect of this invention contemplates a method for providing an analyte ion suitable for analysis of a physical property. That method comprises the following steps:

a) providing a substrate surface with CNTs;
b) providing a quantity of a sample comprising an analyte having a physical property to be determined to the CNT substrate surface; and
c) discharging energy onto the analyte-loaded substrate to provide an ionized analyte.

The energy may be in the form of a radiation, e.g. from a laser.

As an example of a process, which can be used with the present invention, once ionized under reduced pressure, the analyte ion is suitable for analysis to determine a desired physical property. Analyzing the analyte comprises one or more physical methods of analysis that illustratively include mass spectrometry, electromagnetic spectroscopy, chromatography, and other methods of physical analysis known to skilled workers.

Thus, in accordance with a particular embodiment of this invention, a method for determining a physical property of an analyte ion is contemplated. That method comprises the following steps:

a) providing a substrate surface with CNT's;
b) providing a quantity of sample comprising an analyte having a physical property to be analyzed to the obtaining a CNT substrate surface;
c) discharging energy onto the analyte-loaded substrate to provide an ionized analyte; and
d) analyzing the ionized analyte for the physical property.

In a particular embodiment, the determined physical property is mass, and an above-contemplated method for determining a physical property of an analyte ion analyzes the mass to charge ratio (m/z) of the analyte ion by mass spectrometry techniques, such as but not limited to MALDI-MS or SELDI-MS.

According to yet another aspect of the present invention, CNTs are intermixed with the sample in MALDI-like experiments, i.e. as a replacement of conventional matrix material. The CNTs induce and enhance the energy absorption and transport process that results in vaporization of the sample or analytes therein. Thus the invention also relates to a suspension of CNTs for use in classical MALDI analysis.

According to yet another aspect of the present invention, CNTs are used as add-on material, along with other matrix material in MALDI. Thus the present invention further relates to a mixture for use as a matrix in MALDI comprising both a CNT suspension and a conventional matrix material.

Another aspect the present invention relates to an apparatus for providing an ionized analyte for analysis. The apparatus can be provided with one or more substrates, which is a carbon nanotube substrate or a substrate coated with carbon nanotubes. The apparatus also has a source of energy, e.g. of radiation. When the source of radiation irradiates the substrate of the invention on which the analyte is adsorbed, irradiation will cause desorption and ionization of the analyte for analysis.

Another aspect of the invention relates to substrates comprising CNT material, optionally a substrate coated with CNT specifically adapted for use in an apparatus which provides an ionized analyte for analysis, e.g. for use in an desorption/ionization mass spectrometry apparatus.

Thus, the present invention relates to improved methods, apparatuses and material for physical analysis of samples, more particularly for mass spectrum analysis of samples.

More particularly, the present invention relates to improved methods for obtaining diagnostically useful mass spectrometry patterns form serum, fluid and tissue samples for use in diagnostics.

According to another aspect the present invention relates to Mass spectrometric patterns generated using the CNTs of the present invention. Such patterns may be characterized by the presence of characteristic CNT material peaks (when the material of the invention is used as a conventional matrix) or can be characterized by a specific profile due to the interaction between analyte and the CNT substrate material of the invention. A further aspect of this invention thus relates to a data structure comprising the patterns obtained using the substrates of the present invention in a memory.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

The term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

The present invention relates to the use of carbon nanotubes (CNTs) in methods and apparatuses for analysis of chemical analytes and/or bioanalytes.

Carbon nanotubes as used herein relate to structures which consist of graphene cylinders of between 1 and 100 nm in diameter. Their length can vary up to a millimeter long. The kind of nanotube (defined by its diameter, length, and chirality or twist) will determine its electronic, thermal, and structural properties. Nanotubes of the present invention include both single cylindrical wall (single-walled nanotubes or SWNTs), and multiple walls (multi-walled nanotubes or MWNTs), i.e. cylinders inside the other cylinders, as well as other three dimensional structures such as those described in the art including but not limited to ‘carbon nano horns’, ‘carbon nano cones’ and ‘bamboo-type carbon nanostructures’. Moreover, in the context of the present invention CNTs with low defect densities as well as highly defective structures can be used.

Carbon nanotubes can be grown by different methods all of which are included within the scope of the present invention. Suitable techniques include laser ablation of graphite, DC arc discharge growth from graphite or catalyst-supported chemical vapor deposition processes, e.g. thermal CVD or plasma CVD processes. However, the latter techniques, i.e. the CVD techniques and especially microwave plasma CVD, have in the last few years become the most commonly used techniques to grow nanotubes.

In conventional CVD growth techniques for nanomaterials, a stack is formed comprising at least a substrate and a catalyst layer. The substrate may be any suitable substrate with respect to the required application. The catalyst layer may for example be a metal layer such as e.g. Ni, Fe, Co or any other suitable metal The thickness of the catalyst layer will later determine the size of the formed CNTs. In between the substrate and the catalyst layer, optionally, a first buffer may be provided in order to prevent chemical reactions between the catalyst layer and the substrate. The growth method then comprises two steps: a catalyst nanoparticle forming step and a nanomaterial growing step. During the catalyst nanoparticle forming step, the entire stack is heated. Heating may be done by means of a plasma, which will then also be used for the nanomaterial growth. Alternatively, heating may also be performed by any other suitable heat source, such as for example a resistance heater provided underneath the substrate, at the side opposed to the side onto which the first catalyst layer is applied. During this step, the catalyst layer is deformed into catalyst nanoparticles. This structuring of the catalyst layer of the generic stack of substrate/buffer layer (optional)/catalyst layer then leads to structured growth of CNTs and other nano materials by exposure of the stack to a nanomaterial comprising plasma, e.g. a microwave plasma in the subsequent nanomaterial growing step. In general, plasma-grown CNTs can be formed from gas mixtures that contain a carbon carrier (methane, acetylene, other), hydrogen, and other gases (ammonia, nitrogen).

Methods of purifying nanotubes have also been described (H. Hiura et al., 1995, Adv. Mater. 7:275-276; J-M Bonard et al., 1997, Adv. Mater. 9:827-831; G. S. Duesberg et al., 1998, Chem. Commun. 98:435-436). Carbon nanotubes can be grown on different substrates including but not limited to metal, silicon, glass and plastics (Suh and Lee, 1999, Appl. Phys. Lett. 75:2047-2049; Hu et al., 2001, Appl Phys. Lett 79(19):3083-3085; Hofmann et al., 2003, Appl Phys. Lett. 83(22):4661-4663). Plasma deposition techniques moreover allow oriented growth of the CNTs onto support structures (onto a substrate or probe), making it possible to orient the sample along the surface topology to create improved S/N ratios and help to enhance capture probe activity and efficiency. Thus, according to a particular embodiment of the invention the CNTs are aligned following a preferential orientation (e.g. aligned perpendicularly to said surface).

The use of carbon nanotubes according the present invention is envisaged either as a fixed substrate or as surface coating of a substrate or probe or in the form of a suspension for mixing with the sample to be analyzed, alone or in combination with a conventional matrix. Examples of conventional matrices include but are not limited to 2,5-dihydroxy benzoic acid, trans-cinnamic acid or nor-Harmane. Such carbon nanotube-sample mixtures can then be applied to conventional substrates or probes used in desorption/ionization analytics (e.g. in MALDI or SELDI), including, but not limited to substrates made of silicon, metal, rare gas solids etc.

According to a particular embodiment, the carbon nanotubes are modified by organo-chemical reactions in order to e.g. add capture probes or introduce polarities. Methods for the chemical modification or functionalization of carbon nanotubes have been described in the art, including but not limited to the methods described in US US20040018543, WO02/095099, WO02/060812 and WO97/32571 and by TSANG S. C. et al. (1995, J. Chem. Soc. Chem. Comm. 17:1803-1804), DAVIS J. J. et al. (1998, Inorg. Chim. Acta 272:262-266) and Ni and Sinnott (2000, Physical Review B 61(24): 343-346). Chemical modification according to the present invention includes the attachment of one or more functional groups including but not limited to antibodies, DNA strands, RNA strands, amino groups, OH— groups COOH— groups.

According to the present invention carbon nanotubes are used in analysis of a sample, more particularly for the detection of analytes within a sample. The sample can be organic or inorganic chemical composition, a biochemical composition, peptide, polypeptide, protein, carbohydrate, lipid, nucleic acid, cells, cellular structures, micro-organisms or mixtures thereof. Particular examples of proteins include but are not limited to soluble, membrane or transmembrane proteins, enzymes, antibodies, antibody fragments.

According to a particular embodiment of the present invention the sample for analysis is a sample which is obtained from the human body, the animal body or from a plant and optionally pretreated (e.g. purified) before use. The use of carbon nanotubes in the analysis of diagnostic samples ensures increased stability and reproducibility of the results. Thus, the present invention relates to improved methods for obtaining diagnostically useful mass spectrometry patterns from serum, urine, spinal fluid, lymph, saliva or any other bodily fluid or from (optionally processed) tissue samples.

According to one embodiment of the present invention the sample is applied to the carbon nanotubes substrate surface and then analyzed by a detection means. More particularly the analysis involves discharging an energy source onto the sample, whereby the analytes in the sample are charged, (selectively) released from the substrate and typically entered into a vacuum having an electric field which induce a movement through or towards a detection device.

The ionized/gaseous form of the sample can be obtained using different techniques ranging from evaporation to ion beam bombardment, depending on the sample and the detection means used. Different kinds of light sources can be used, e.g. high power LEDs (broad-band or with specific colors), discharge lamps (with photographic flash lights one can ignite CNTs to burn in oxygen). Alternative energy sources include non-photonic energy sources (such as electrical currents, e-beams, ion beams etc.). According to a particular embodiment the material of the present invention is used as a substrate surface for laser desorption/ionization. Different types of mass spectrometry are envisaged within the context of the present invention including, but not limited to, techniques referred to as matrix associated laser desorption/ionization (MALDI) and surface enhanced laser desorption/ionization spectrometry (SELDI). More particularly, the use of the CNTs of the present invention is envisaged in the context of MALDI or SELDI in combination with time-of-flight (TOF) analysis for Mass spectrometry (MS). The use of CNTs in desorption/ionization techniques can be summarized under the acronym CANALDI (Carbon Nanotube Assisted Laser Desorption Ionization).

According to a particular embodiment of the invention alternating or pulsed electrical potentials are applied as close as possible to the substrate CNT surface, so as to allow selective adsorption or desorption of particular analytes from said surface using laser desorption.

The sample can be applied to the CNT substrate surface by a variety of different means, including but not limited to adsorption from a solid, liquid or gas or by direct application to the surface of the substrate as a solid or liquid. Optionally, the sample can be applied to the substrate surface directly from a chemical separation means such as, but not limited to, liquid chromatography, gas chromatography, and deposited thin-film chromatography.

The detection device used in the analysis of samples within the context of the present invention includes mass spectroscopy, more particularly using time of flight (TOF) analysis for species identification. Optionally, according to the present invention, the CNTs are modified in order to select different charge states of the sample or its analytes, and can be used in state of the art MALDI or SELDI whereby a potential of appropriate polarity is applied.

According to a further embodiment, the carbon nanotubes are loaded with hydrogen, so as to foster excited state proton transfer. Hydrogen can be introduced during the production process, e.g. during microwave plasma deposition as described above, or can be introduced by chemical reactions after the production, e.g. electrochemical modification or by hydrogen plasma surface treatment. Electrochemical modification by hydrogen is known in case of single walled carbon nanotubes (SWNTs) and may be carried out in an electrochemical cell with for example an aqueous solution of KOH as an electrolyte. The SWNTs are incorporated in the electrochemical cell as self-assembled sheets of SWNT as the negative electrode. Electrolysis is then carried out for a few hours generating protons, which are then attracted to the SWNT electrode. The SWNT electrodes need to be modified prior to charging, either by a slow heat treatment protocol in argon or by gentle oxidization under low pressure of water vapor Owens F. Iqbal Z., Abstract of poster LP-11 at 23^{rd} Army Science Conference, Dec. 2-5, 2002). Hydrogen plasma surface treatment has the following effects. First, the dangling bonds on the surface of diamond carbon composite can be chemically terminated by atomic hydrogen, and, generally, the C—H bonds form a dipole because of the different electronegativity. Second, as a result of the ion bombardment etching process will generate a large amount of defects and change the surface structure of diamond carbon composite material.

Alternatively, other methods of detection can be envisaged within the context of the invention including detection methods based on antigen-antibody reaction, fluorescence detection means, optical detection means, radioactivity detection means, electrical detection means, chemical detection means, antigen-antibody reaction detection and combinations thereof.

The following, not intended to limit the invention to specific embodiments described, may be understood in conjunction with the accompanying figure, in which:

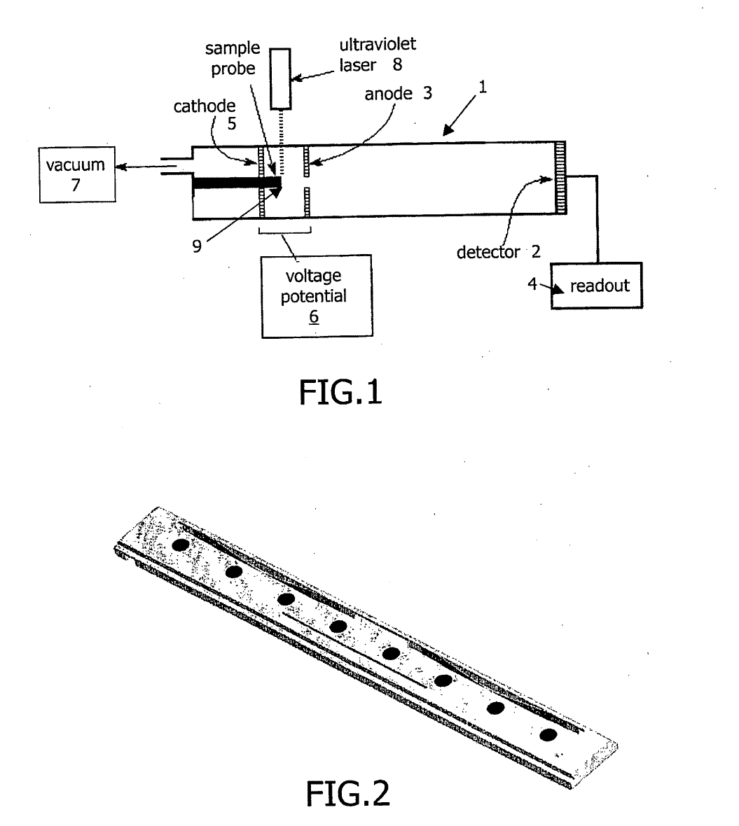

FIG. 1 Schematic representation of a desorption-ionization mass spectrometry (DI-MS) apparatus.

FIG. 2 Illustration of a substrate suitable for performing CANALDI on a classical apparatus suitable for ionization/desorption analysis.

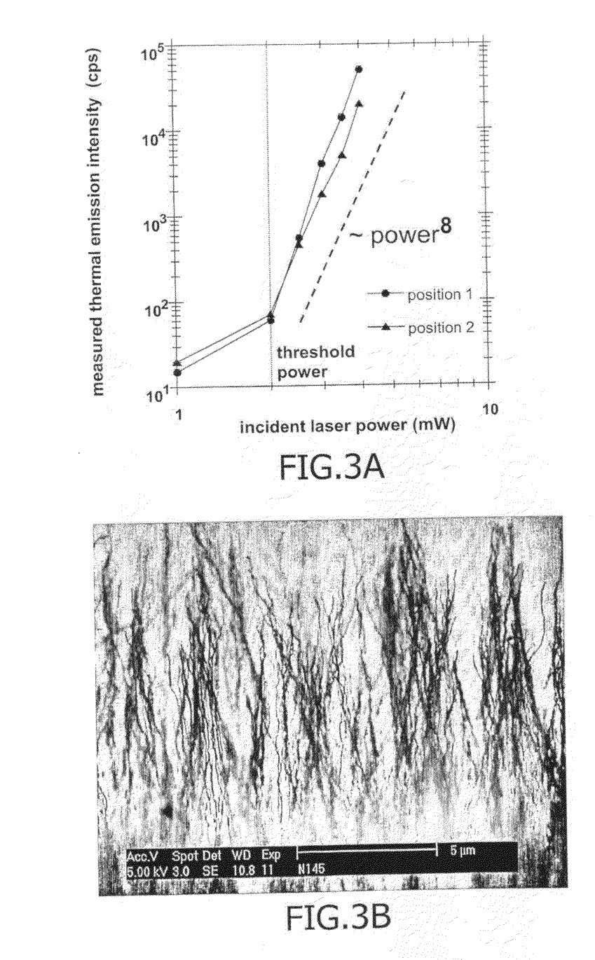

FIG. 3 Rapid thermal heating of CNTs upon irradiation with 514 nm laser light (A) and corresponding microwave-plasma-deposited highly oriented multi-walled CNTs (B).

### EXAMPLE 1

### Desorption-Ionization Apparatus

FIG. 1 shows a schematic representation of a desorption-ionization apparatus, such as a DI-MS, e.g. a MALDI apparatus or for example a SELDI apparatus, with which the present invention may be used. It comprises a hollow chamber 1 with a probe sample 9 located in the chamber. The chamber is held under vacuum by a vacuum pump 7. A source of energy 8 is arranged and so directed that analytes on the probe sample 9 can be ionized. For example, the source of energy can be a laser, e.g. an ultraviolet laser. The ionized analytes are drawn away from the probe sample by an electric and/or magnetic field generated by a field generator 6. For example, an electric potential may be applied between two electrodes 3, 5 in a series arrangement. The accelerated ionized analytes are then detected at a detector 2 having read out electronics 4. The detector may be placed at a certain distance from the probe sample and the read out electronics may be used for Time-of-Flight determinations of the ionized analytes.

Any CNT substrate surface of the invention can be provided onto the sample probe, or as matrix material in a conventional DI-MS, e.g. MALDI set-up.

### EXAMPLE 2

### Desorption-Ionization Device

FIG. 2 shows a carrier in accordance with an embodiment of the present invention for use in desorption-ionization apparatus. A metal (aluminium) frame or holder is covered by a silicon strip on which CNTs are grown in the form of circular 2 mm diameter regions (black).

### EXAMPLE 3

### Thermal Emission of CNTs Upon Laser Irradiation

The CNT sample was grown by microwave plasma chemical vapor deposition. Other CNT growth methods, for example thermal chemical vapor deposition or RF-plasma enhanced chemical vapor deposition are also feasible and result in oriented CNTs.

The CNTs were grown using an iron catalyst layer of 2 nm on a silicon substrate. Hydrogen was introduced into the microwave plasma reactor at a rate of 200 sccm. The pressure of the reactor was kept at 28 mbar. The substrate was heated to 60° C. and a 1 kW 2.45 GHz microwave plasma was ignited. 10 sccm of methane was added to the gas phase inside the reactor while the pressure was kept constant. After 1 min of growth time, 5 μm long vertically aligned, electrically conductive CNTs were grown (see illustration in FIG. 3A).

Peptides are immobilized on the oriented, vertically aligned CNTs, and the sample is exposed in vacuum to 514 nm laser light. After increase of the laser power above threshold which is determined by the material, substrate and the environment, thermal emission from the CNT increases according to the eighth power of incident laser intensity, indicating a corresponding, extremely fast T-increase of the structure (as illustrated in FIG. 3B). Rapid heating leads to efficient vaporization of the biopolymers for subsequent mass spectroscopy.

### EXAMPLE 4

### Analysis of a CNT-Peptide

Commercially available (Iljin Co, Korea), 60 μm long CNTs are impregnated with a peptide solution, transferred into a conventional 96-well MALDI-TOF substrate plate. The mixture is dried in vacuum and exposed (in vacuum) to 514 nm laser light. After increase of the laser power above a material, substrate and environment dependent threshold, thermal emission increase indicates extremely fast T-increase of the CNT/biopolymer combination. Rapid heating leads to efficient vaporization of the biopolymers for subsequent mass spectroscopy.

### EXAMPLE 5

### Mass Spectra Stored in a Memory Device

Mass spectrometric patterns generated using the CNTs of the present invention may be characterized by the presence of characteristic CNT material peaks (when the material of the invention is used as a conventional matrix) or can be characterized by a specific profile due to the interaction between analyte and the CNT substrate material of the invention. A further aspect of this invention thus relates to a data structure comprising the patterns obtained using the substrates of the present invention stored in a memory device, e.g. a diskette, a solid state storage device such as a memory of a computer or a memory of a network device, an optical storage device such as a CD-ROM or a DVD-ROM, or a tape storage device.

It is to be understood that although preferred embodiments, specific constructions and configurations, as well as materials, have been discussed herein for devices according to the present invention, various changes or modifications in form and detail may be made without departing from the scope and spirit of this invention.

1. The use of carbon nanotubes in a method for desorption/ionization analytics.

2. The use of claim 1, wherein said carbon nanotubes are preferentially oriented.

3. The use of claim 1, wherein said carbon nanotubes are chemically modified.

4. The use of claim 3, wherein said chemical modification involves the attachment of one or more functional groups including but not limited to amino groups, OH— groups COOH— groups.

5. The use of claim 3, wherein said carbon nanotubes are chemically modified by introduction of hydrogenation.

6. The use of claim 1, wherein said carbon nanotubes are used as the surface of a fixed substrate or a fixed substrate coating.

7. The use of claim 1, wherein said carbon nanotubes are used in the form of a suspension.

8. The use of claim 1, wherein said method is mass spectrometry analysis.

9. The use of claim 1, wherein said CNTs are obtained by plasma vapor deposition.

10. A method for the analysis of a sample comprising the steps of: (a) applying a sample to a substrate provided with a carbon nanotube surface; and (b) analyzing said sample by a detection means.

11. A method for the analysis of a sample comprising the steps of: (a) applying a mixture of a sample and a carbon nanotube suspension to a probe suitable for desorption/ionization analytics; and (b) analyzing said sample by a detection means.

12. The method according to claim 10, wherein said sample is selected from the group consisting of: organic chemical compositions, inorganic chemical compositions, biochemical compositions, cells, micro-organisms, peptides, polypeptides, proteins, lipids, carbohydrates, nucleic acids, or mixtures thereof.

13. The method of claim 10, wherein said sample is a biological sample of tissue, fluid or serum collected from a human, animal or plant.

14. The method according to claim 10, wherein said carbon nanotubes are attached to a surface and are aligned perpendicularly to said surface.

15. The method according to claim 10, wherein an electrical potential is applied to the carbon nanotube surface.

16. The method according to claim 10, wherein said carbon nanotubes are chemically modified.

17. The method of claim 16, wherein said chemical modification includes the attachment of one or more functional groups including but not limited to amino groups, OH— groups COOH— groups.

18. The method of claim 16, wherein said carbon nanotubes are chemically modified by introduction of hydrogenation.

19. Apparatus for desorption/ionization analytics, comprising:
a substrate provided with carbon nanotubes,
a source of energy for directing energy onto the substrate, and
detection means for analyzing substances emitted from said substrate.

20. The apparatus of claim 19, further comprising means for applying a sample to the substrate provided with carbon nanotubes.

21. The apparatus of claim 19, wherein said carbon nanotubes are attached to the surface and are aligned perpendicularly to said surface.

22. The apparatus according to claim 19, further comprising means to apply an electrical potential to the carbon nanotube surface.

23. The apparatus according to claim 19, wherein said carbon nanotubes are chemically modified.

24. The apparatus of claim 23, wherein said chemical modification includes the attachment of one or more functional groups including but not limited to amino groups, OH— groups COOH— groups.

25. The apparatus according to claim 23, wherein said carbon nanotubes are chemically modified by introduction of hydrogenation.

26. A sample probe adapted for use in an apparatus for mass spectrometry characterized in that it comprises a substrate with a carbon nanotube surface.

27. The sample probe of claim 26, wherein said carbon nanotubes are preferentially oriented.

28. The sample probe of claim 26, wherein said carbon nanotubes are chemically modified.

29. The sample probe of claim 28, wherein said chemical modification involves the attachment of one or more functional groups including but not limited to amino groups, OH— groups COOH— groups.

30. The sample probe of claim 28, wherein said carbon nanotubes are chemically modified by introduction of hydrogenation.
